(19) United States
(12) Patent Application Publication
(10) Pub. No.: US 2006/0272998 A1
(43) Pub. Date: Dec. 7, 2006

(54) Permeate connection for immersed membrane

(76) Inventor: Arnold Janson, Burlington (CA)

Correspondence Address: BERESKIN AND PARR, 40 KING STREET WEST, BOX 401, TORONTO, ON, M5H 3Y2, CA

(21) Appl. No.: 11/443,194

(22) Filed: May 31, 2006

Related U.S. Application Data
(60) Provisional application No. 60/685,421, filed on May 31, 2005.

(51) Int. Cl. B01D 63/00

(52) U.S. Cl. 210/321.61; 210/321.6

(57) ABSTRACT

An apparatus or system has a permeate pipe, alternately called a header, connected to a membrane unit, alternately called a cassette or a train of cassettes. A tank for holding the membrane unit has a notched portion in a top edge of a wall of the tank for receiving the permeate pipe. One or more members of fillers substantially fill the area of the notched portion not occupied by the permeate pipe. One or more seals seal the outside of the permeate pipe, directly or indirectly, for example through the filler or member, to the tank wall. The membrane unit may be installed by lowering it into the tank such that the permeate pipe is lowered into the notch, placing the one or more fillers in position in the notch and effecting the one or more seals.

This is an application claiming the benefit under 35 USC 119(e) of U.S. patent application Ser. No. 60/685,421 filed May 31, 2005. Application Ser. No. 60/685,421 is incorporated herein, in its entirety, by this reference to it.

### FIELD OF THE INVENTION

The invention relates to permeate pipe connectors, connection systems or methods of connecting permeate pipes, for example in an immersed membrane system.

### BACKGROUND OF THE INVENTION

In immersed membrane filtration, a membrane module or cassette is immersed in a tank of water at ambient pressure. The module or cassette has a permeate (filtrate) outlet in communication with the membranes. While the module or cassette is in use, this permeate outlet is connected to a permeate tube, which is in turn connected to a source of suction. However, to allow for fast installation and to allow a module or cassette to be periodically removed for maintenance, a releasable connection is provided between the module or cassette and the permeate pipe. This connection is typically provided above the surface of the water since, in this location, it may be connected or disconnected without entering the tank and there is no danger of dirty feed water entering into a leaky connection.

### SUMMARY OF THE INVENTION

This summary is intended to introduce the reader to the invention but not to define the invention. The invention may reside in any combination of one or more of the apparatus elements or process steps described anywhere in this document. It is an object of this invention to improve on the prior art or to provide a useful alternative to the prior art. It is an alternate object of this invention to provide a permeate pipe connector or seal, or connection or sealing system, or process for constructing an immersed membrane system or process for making permeate connections or a water treatment system having a permeate connection or seal.

In one aspect, the invention provides an apparatus or system having a permeate pipe, alternately called a header, connected to a membrane unit, alternately called a cassette or a train of cassettes. A tank, which may be called a membrane tank or a ZW tank, for holding the membrane unit has a notched portion in a top edge of a wall of the tank for receiving the permeate pipe. One or more members of fillers substantially fill the area of the notched portion not occupied by the permeate pipe. One or more seals seal the outside of the permeate pipe, directly or indirectly, for example through the filler or member, to the tank wall. The membrane unit may be installed by lowering it into the tank such that the permeate pipe is lowered into the notch, placing the one or more fillers in position in the notch and effecting the one or more seals. The permeate pipe can then be connected to other permeate pipes outside of the tank despite the permeate pipe passing through the wall of the tank. Because a connection with other permeate pipes is outside the tank, a leak in such a connection will not admit solids in the tank water into the permeate pipe.

### BRIEF DESCRIPTION OF THE DRAWINGS

Exemplary embodiments will now be described with reference to the following figures:

FIGS. 1-5 show a first embodiment.

FIGS. 6-17 show a second embodiment.

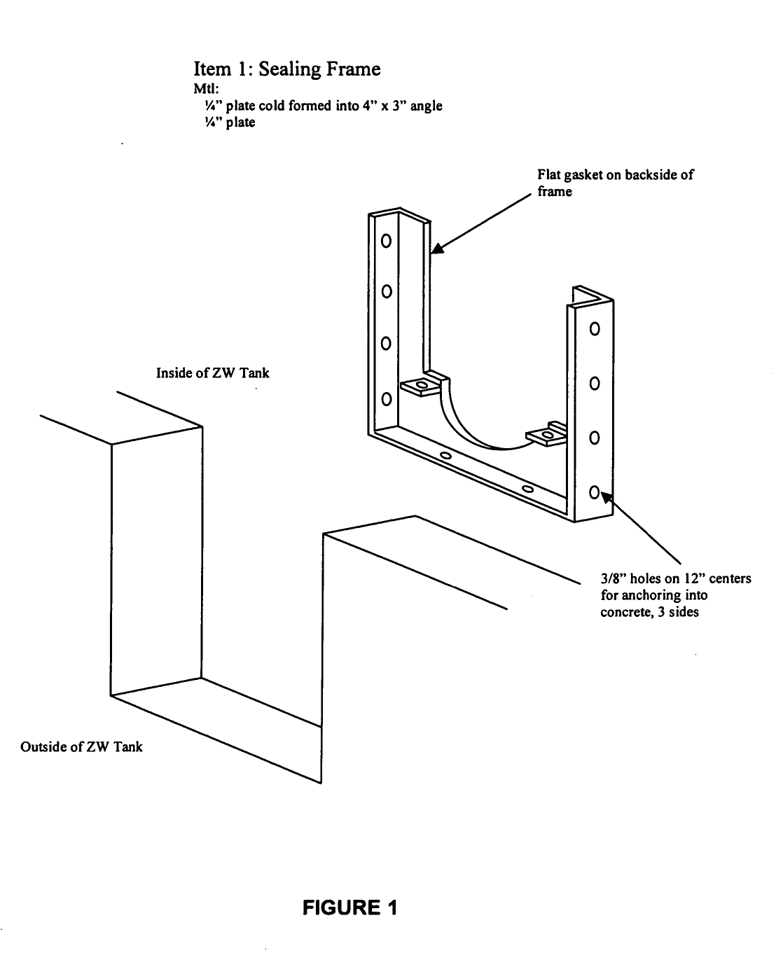

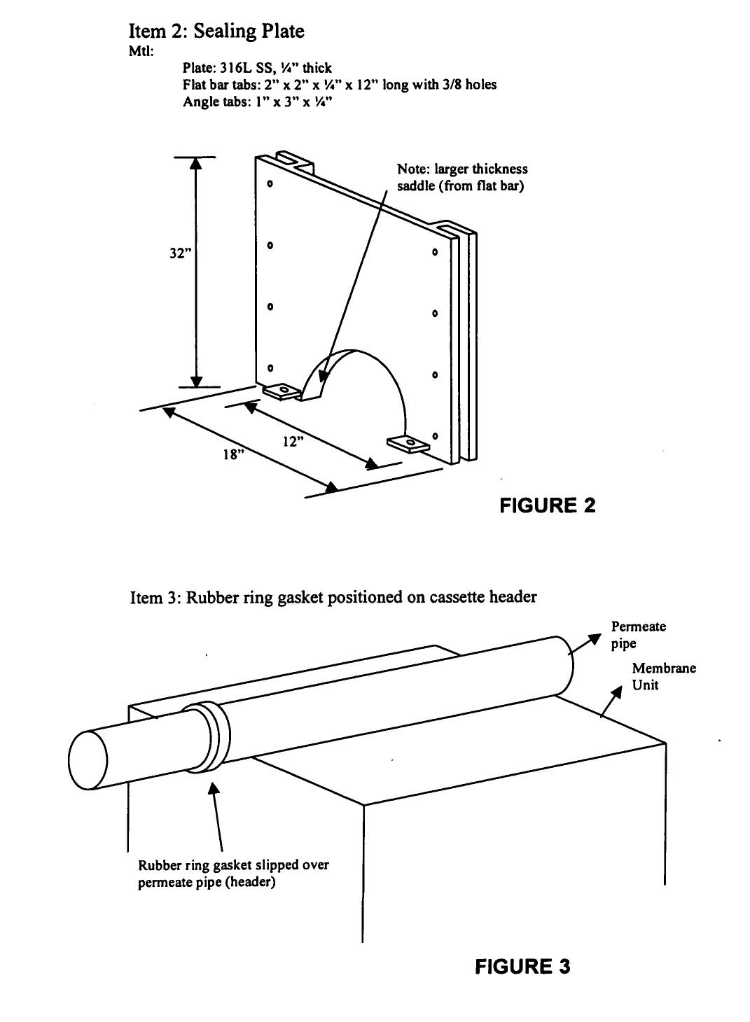

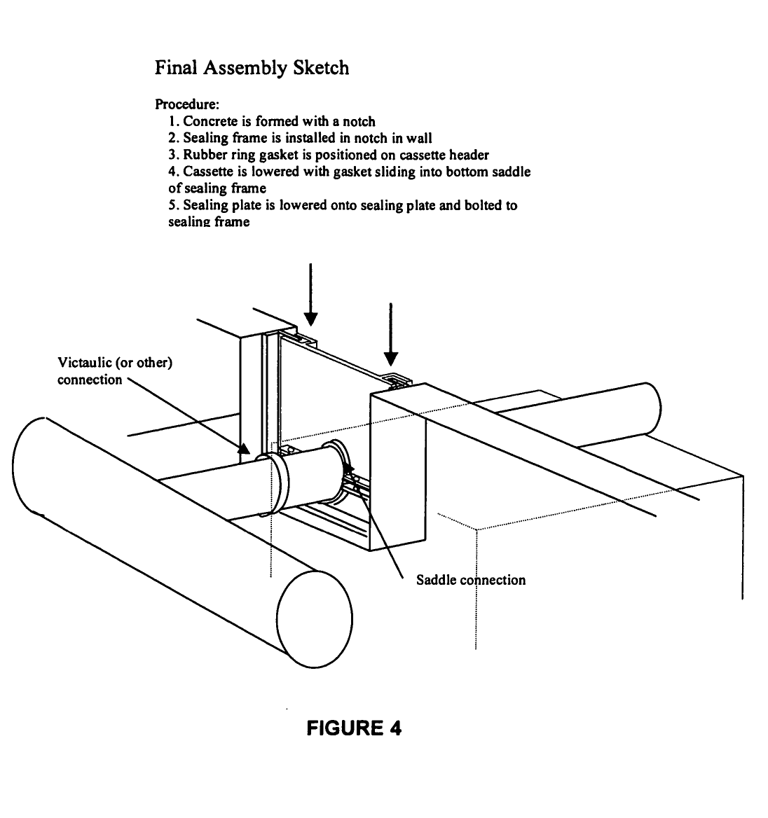

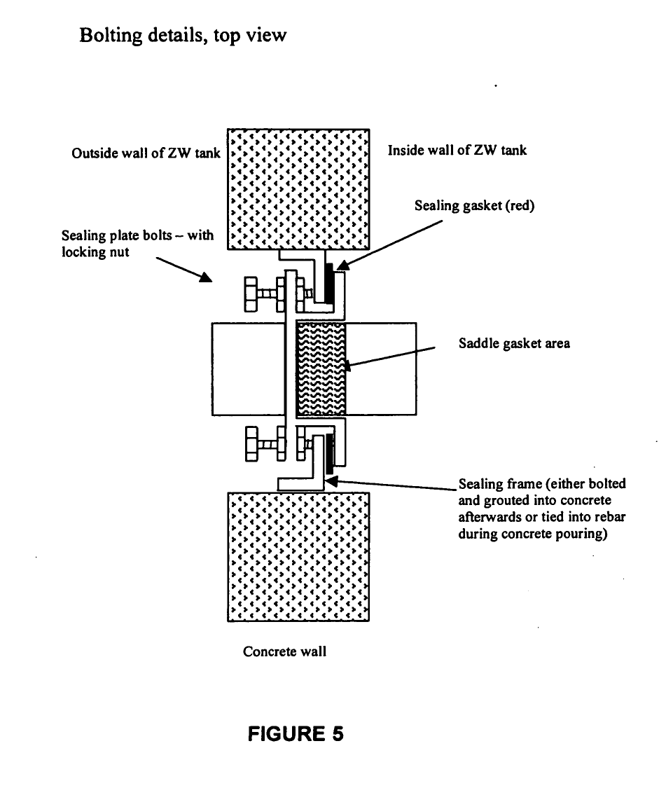

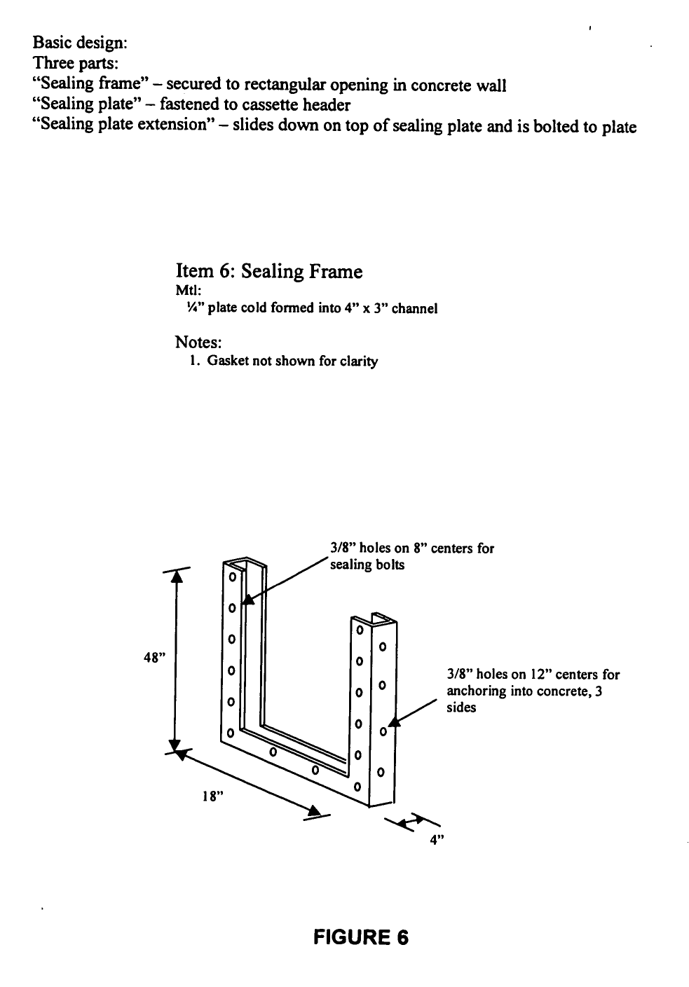

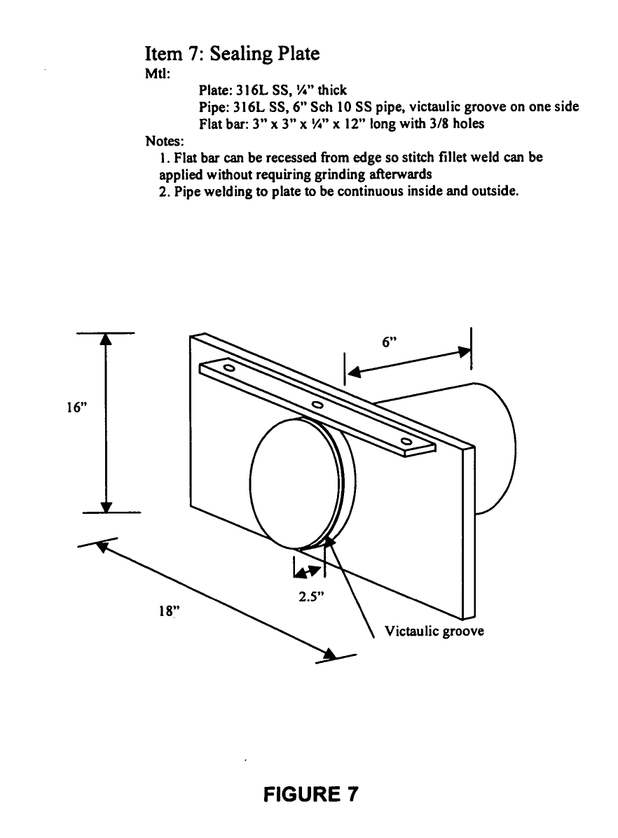

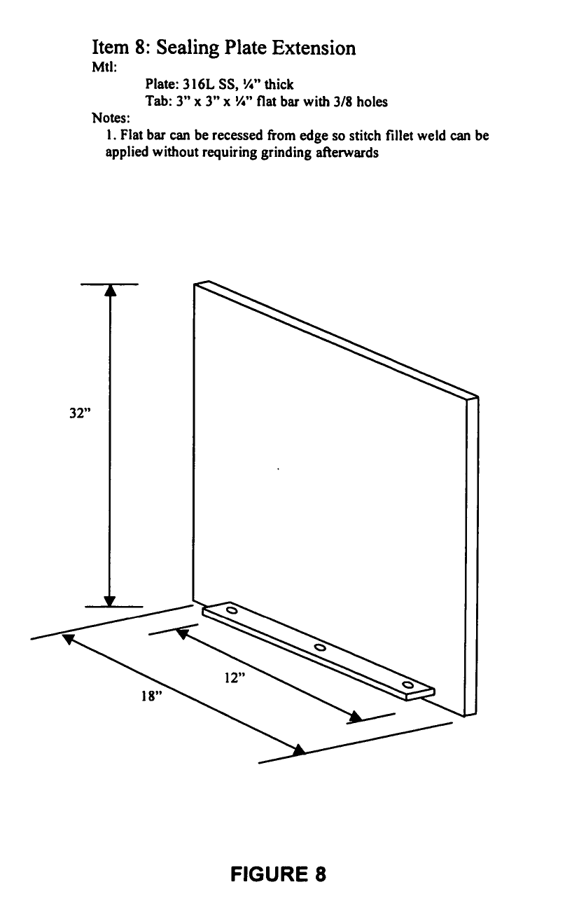

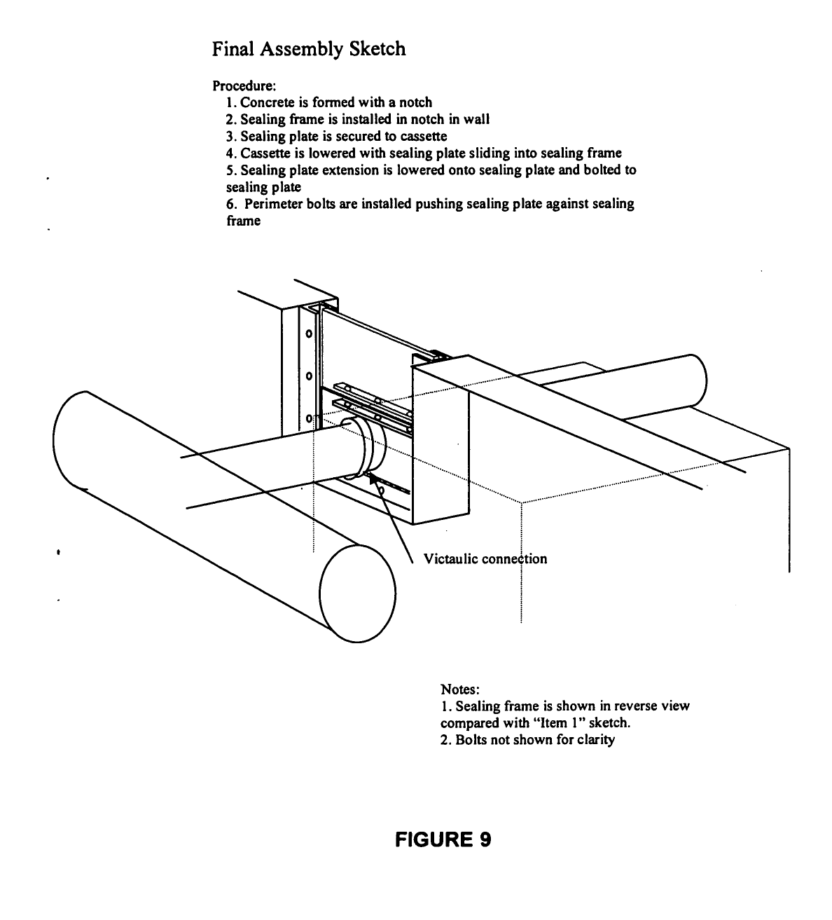

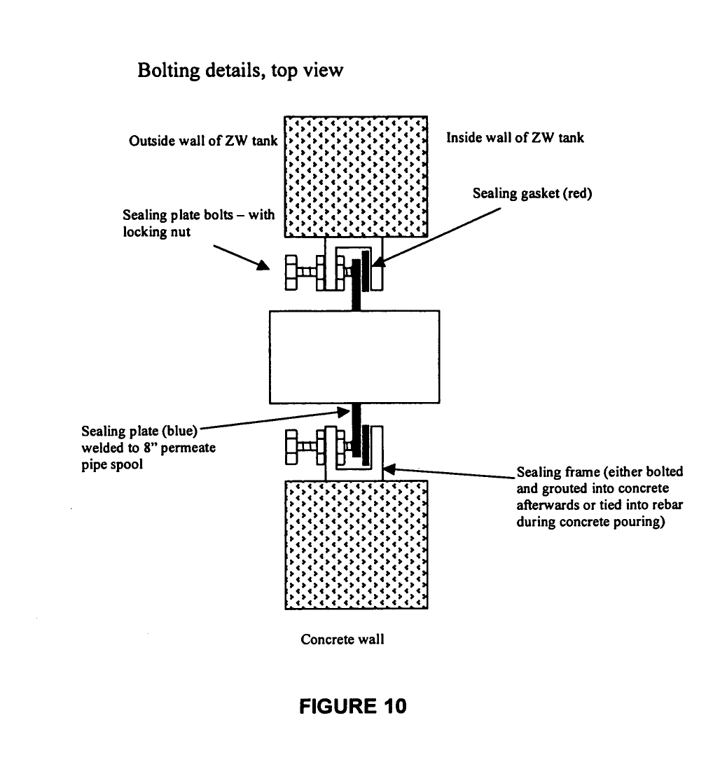

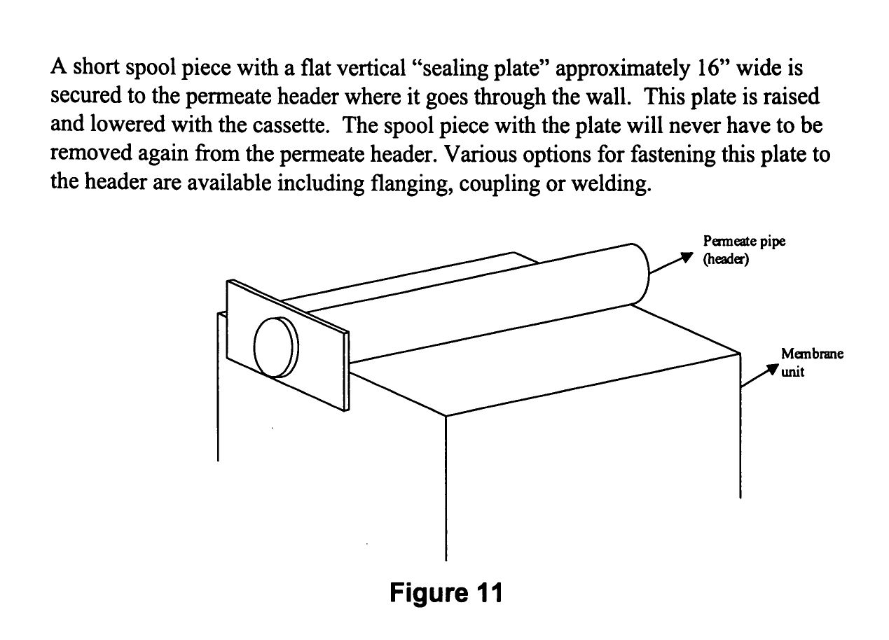

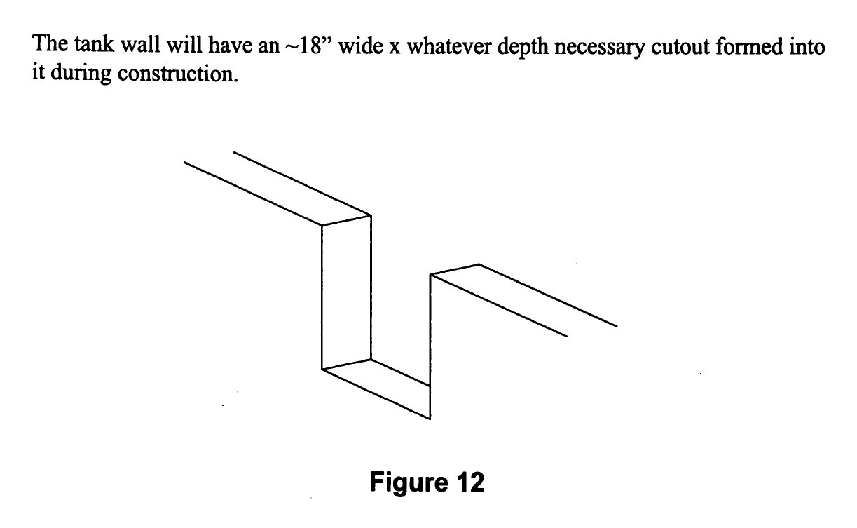

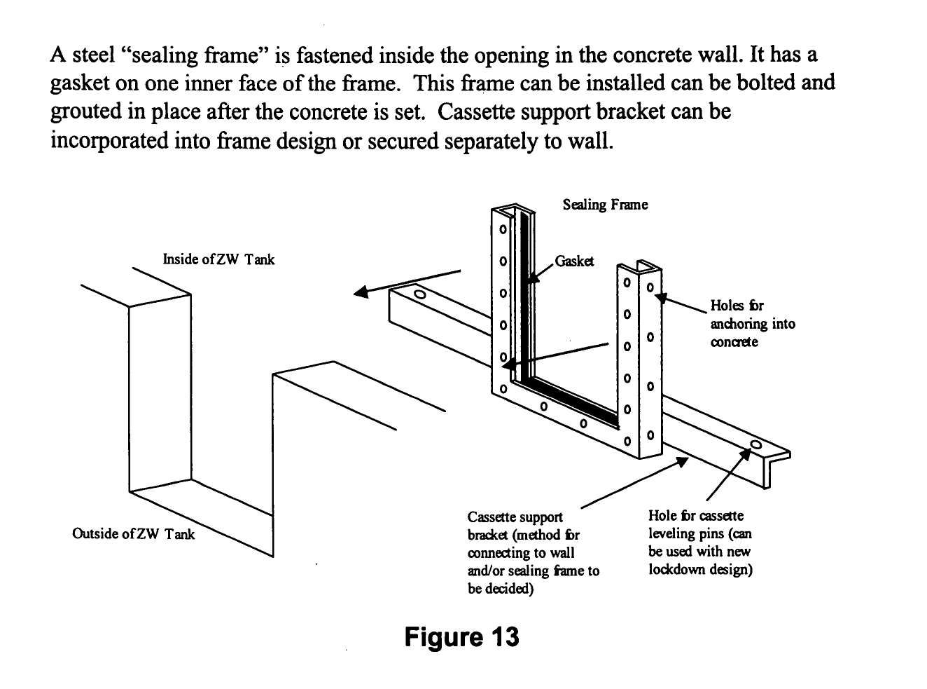

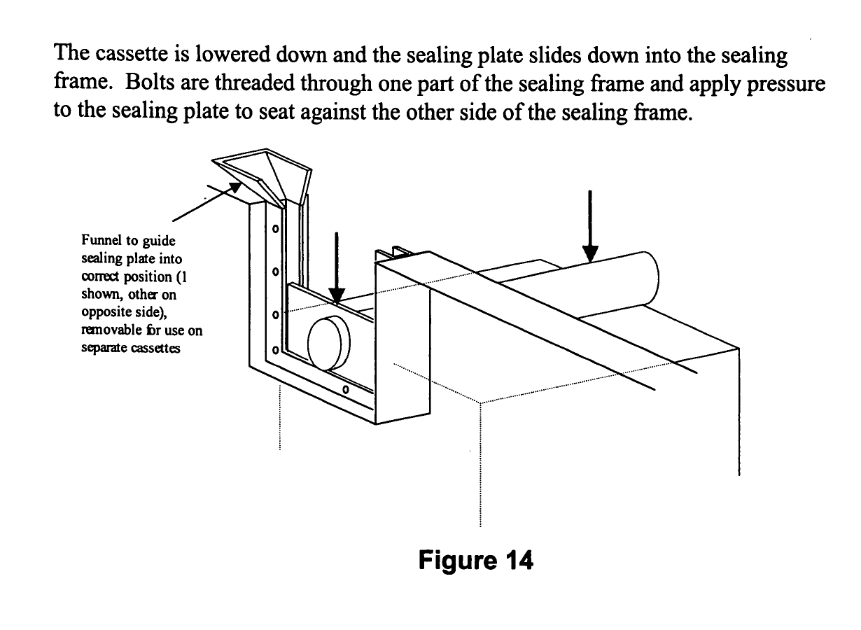

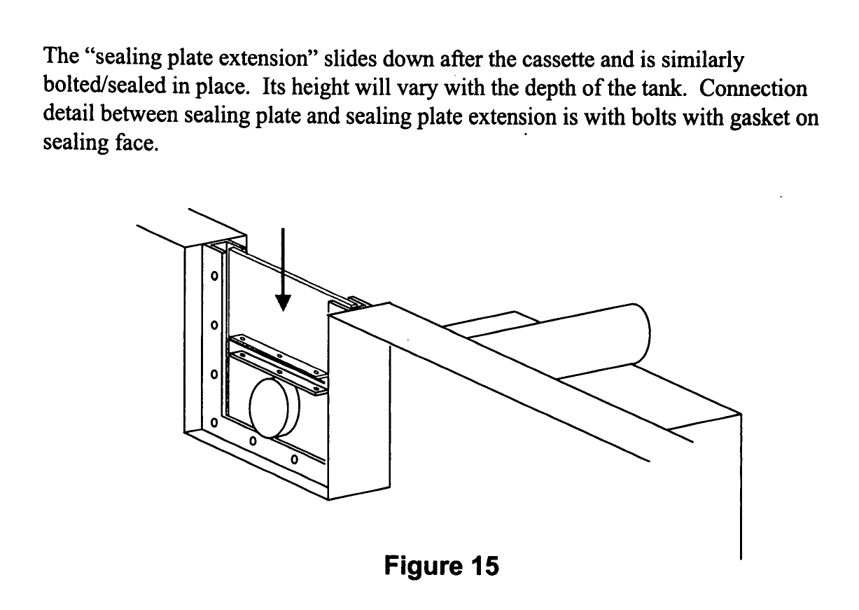

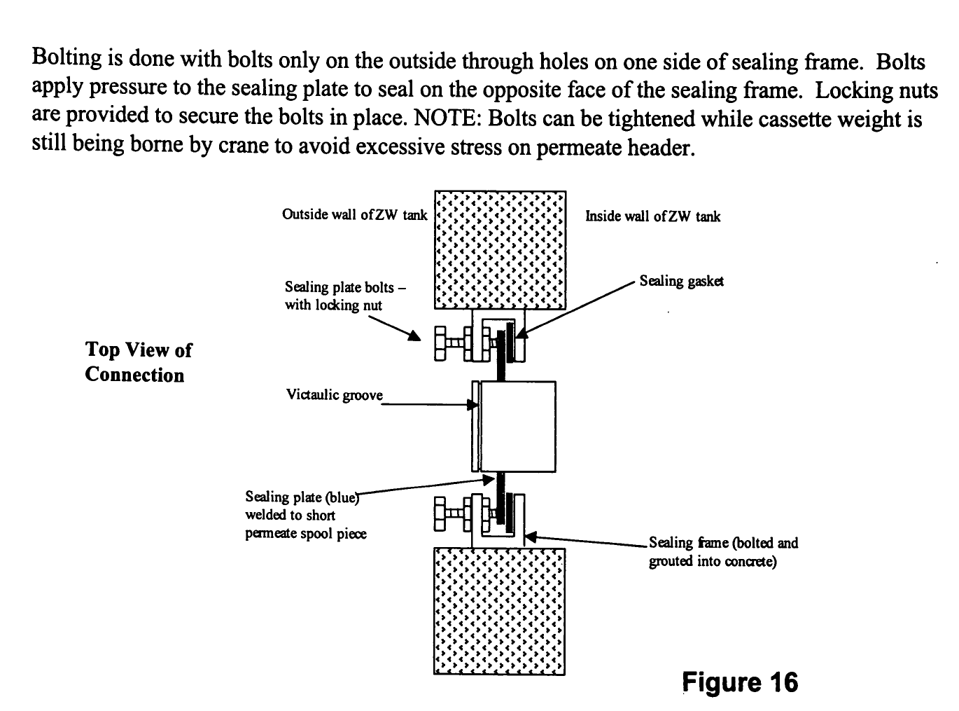

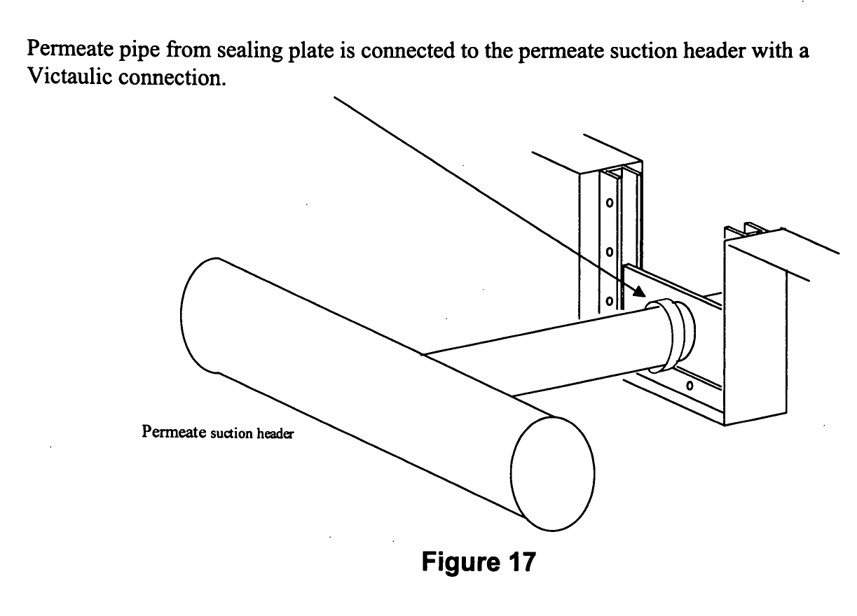

### DETAILED DESCRIPTION OF THE INVENTION

Exemplary embodiments of the invention are described in the Figures. The invention is not limited to the embodiments.

I claim:

1. An apparatus comprising:
a) a tank having a notch in a wall;
b) an immersed membrane unit located in the tank and having a permeate pipe passing through the notch; and,
c) one or more seals between the permeate pipe and the periphery of the notch.

2. A method of constructing an immersed membrane system comprising the steps of:
a) providing a tank having a notch in a wall;
b) lowering an immersed membrane unit having a permeate pipe into the tank such that the permeate pipe passes into the notch; and,
c) sealing the permeate pipe to the notch so as to permit the tank to hold water to at least the bottom, or optionally the top, of the permeate pipe.

3. A seal between a notch in a tank and a permeate pipe comprising:
a) a first member attached to the periphery of the notch;
b) a second member attached to the permeate pipe; and,
c) one or more releasable seals between the first and second members.

4. The seal of claim 3 wherein the second member may be lowered generally vertically in position relative to the first member.

5. The seal of claim 3 further comprising a third member and one or more releasable seals between the third and the first member and the second member.
